(19) United States
(12) Patent Application Publication
(10) Pub. No.: US 2008/0098650 A1
(43) Pub. Date: May 1, 2008

(54) SPROUT CULTIVATION DEVICE

(76) Inventor: Mao-Sheng LEE, Tainan City (TW)

Correspondence Address: LEONG C LEI, PMB # 1008, 1867 YGNACIO VALLEY ROAD, WALNUT CREEK, CA, 94598, US

(21) Appl. No.: 11/554,032

(22) Filed: Oct. 30, 2006

(51) Int. Cl. A01H 3/00

(52) U.S. Cl. 47/58.1 R

(57) ABSTRACT

A sprout cultivation device contains a watering member stacked on top of a multi-leveled close rack with an open bottom where a culture dish for sprouts is positioned at each level. The watering member contains a water basin with a mist maker inside and a heat exchanging element attached to the side of the water basin. A control element of the watering member periodically engages the mist maker to turn the water in the water basin into mist and the heat exchanging element to adjust the temperature of the water. A water refiller automatically refills the water basin from a water bottle until the water level of the water basin reaches a threshold. The mist descends down the levels of the rack to irrigate the sprouts in each culture dish.

(a) Technical Field of the Invention

The present invention generally relates to spout cultivation devices, and more particularly to a sprout cultivation device providing automatic and periodical irrigation to the sprouts.

(b) Description of the Prior Art

A conventional sprout cultivation device 1 is depicted in FIG. 1, which is basically an open-top container closed by a cover 12. The sprouts 11 and the water for their growth are stored in the container. When there is not enough water in the container, the cover 12 has to be opened for refilling.

The appropriate growth temperature for the sprouts 11 is between 18° C. and 25° C. The foregoing close environment of the conventional sprout cultivation device 1 obviously cannot offer the appropriate growing condition for the sprouts 11. In other words, the growth of the sprouts 11 is inevitably affected by the season change and weather. In addition, as water is statically stored in the container and the sprouts are constantly submerged in the water, bacteria would grow inside the container, significantly affecting the quality and hygiene of the sprouts 11. Furthermore, as the cover 12 has to be opened constantly for inspection and refilling, this not only is inconvenient but also increases the possibility that the sprouts 11 are polluted by the bacteria in the air.

### SUMMARY OF THE INVENTION

A sprout cultivation device which provides automatic and periodical irrigation is provided herein. The sprout cultivation device contains a watering member stacked on top of a multi-leveled close rack with an open bottom where a culture dish for sprouts is positioned at each level.

The watering member contains a water basin with a mist maker inside and a heat exchanging element attached to the side of the water basin. A control element of the water member periodically engages the mist maker to turn the water in the water basin into mist and the heat exchanging element to adjust the temperature of the water. A water refiller automatically refills the water basin from a water bottle until the water level of the water basin reaches a threshold.

The mist descends down the levels of the rack to irrigate the sprouts in each culture dish. The extraneous moist is collected by a water collection dish beneath the open bottom of the rack. Each level of the rack has a flappable door for easy accessing the culture dish inside.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a sectional view showing a conventional sprout cultivation device.

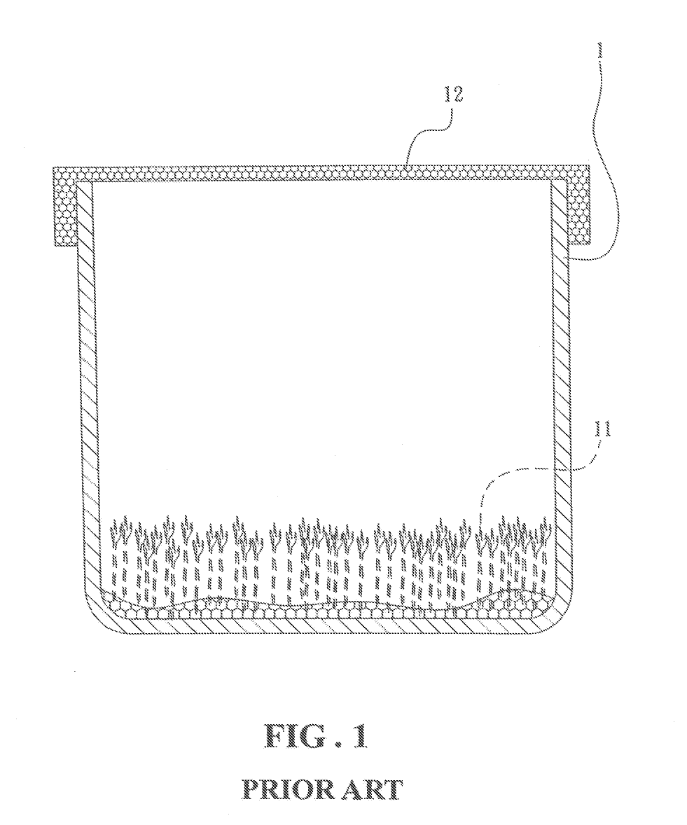

FIG. 2 is a perspective exploded view showing the various components of a sprout cultivation device according to an embodiment of the present invention.

FIG. 3 is a sectional view showing the sprout cultivation device of FIG. 1.

FIG. 4 is a sectional view showing the watering member of the sprout cultivation device of FIG. 1.

FIG. 5 is a top view showing the sprout cultivation device of FIG. 1.

FIG. 6 is a sectional view showing the operation scenario of the sprout cultivation device of FIG. 1.

FIG. 7 is a perspective view showing the disassembly of the sprout cultivation device of FIG. 1 and the storage of the parts in a box.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

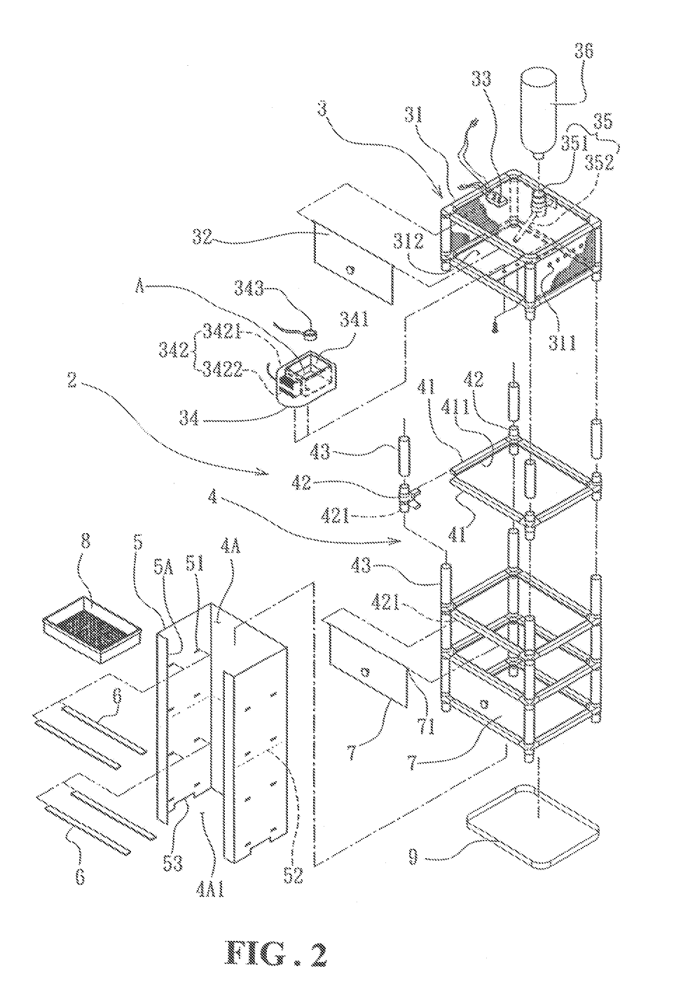

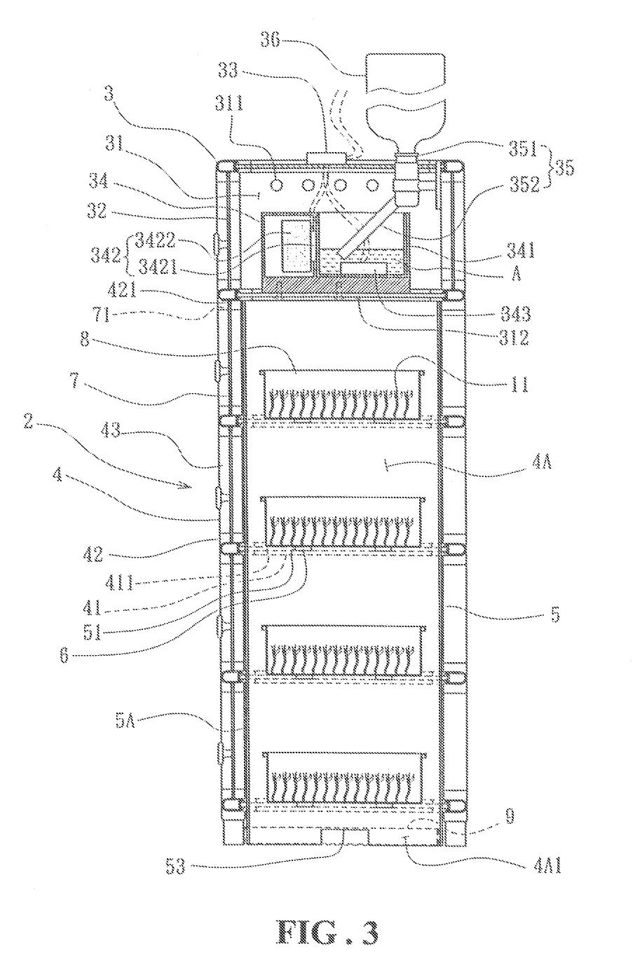

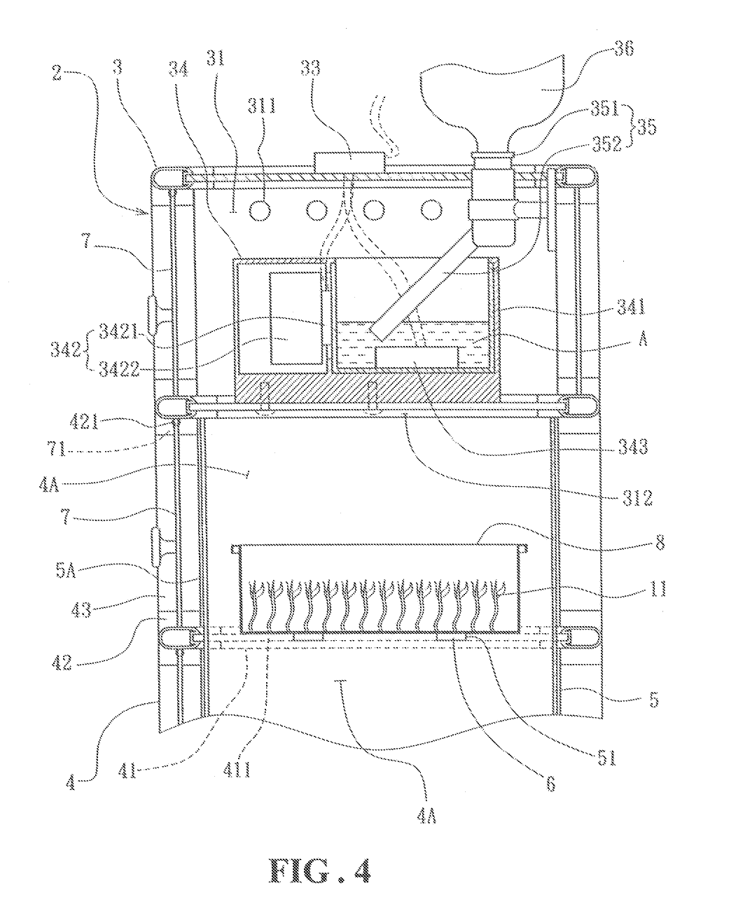

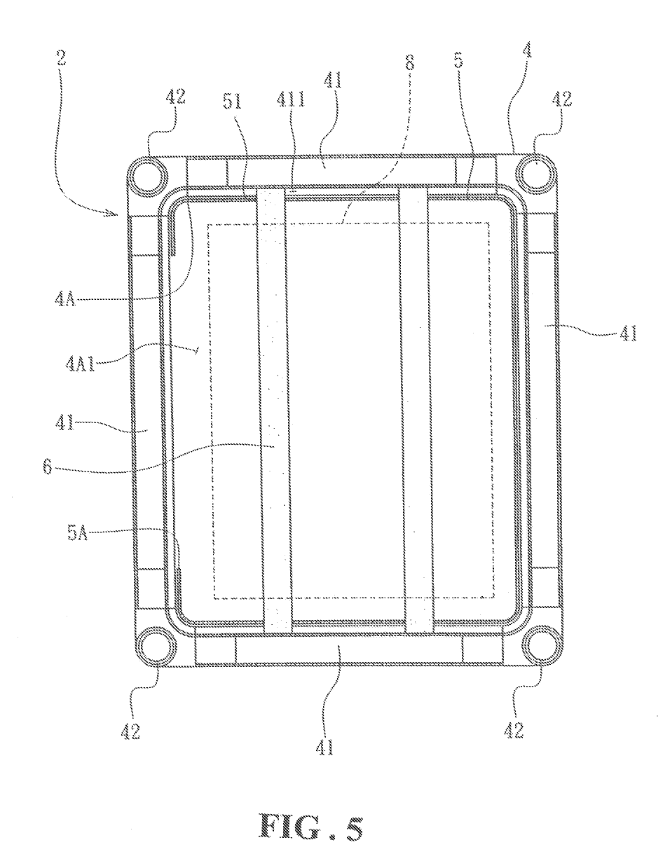

As illustrated in FIGS. 2 to 5, a sprout cultivation device 2 for sprouts 11 according to an embodiment of the present invention contains a multi-leveled rack 4. The rack 4 is formed by stacking a number of shelf members vertically one upon another. Each shelf member contains four corner elements 42 and four tubular lateral segments 41 with each lateral segment 41 connecting two neighboring corner elements 42, thereby forming a rectangular frame. Each shelf member also contains four tubular vertical segments 43 joined to the top of the four corner elements 42, respectively, thereby forming the support to the shelf member stacked above.

A shield member 5 having a U-shaped cross-section is placed inside the rack 4, thereby forming a space 4A with an open top, an open bottom 4A1, an open front side 5A, and close left, right, and back sides. Please note that each lateral segment 41 has a lateral slit 411 facing the slit 411 of the opposing lateral segment 41 after each shelf member is assembled. Correspondingly, the shield member 5 has a number of slits 51 on the left and right walls so that a number of narrow strips 6 are laterally positioned with their two ends threading through the slits 51 and 411, respectively, thereby partitioning the space 4A into a number of levels. Please also note that the shield member 5 has a perforation 52 in the middle along its circumference for folding. The shield member 5 also has indentations 53 along its bottom edge for ventilation. Please further note that the two corner element 42 in the front of each shelf member have opposing holes 421 beneath the connecting lateral segment 41. Therefore, a door 7 is installed in front of each shelf member to cover the open front side 5A by having two pins 71 at the top left and right corners of the door 7 plugged into the holes 421, respectively. The door 7 thereby can be flipped open to access the space inside.

As described above, a culture dish 8 having sprout seeds inside can be placed on the strips 6 of each shelf member. In addition, a water collection dish 9 is placed beneath the open bottom side 4A1 for collecting the extraneous moist within the space 4A.

A watering member 3 is stacked on the topmost shelf member of the rack 4. The watering member 3 is similarly structured to the shelf member and thereby provides a chamber 31 with close top, left, right, and back sides, an open bottom side 312, and a flippable door 32 on the front side. The left and right sides have ventilation holes 311. A mist production element 34 is held inside the chamber 31, which contains a water basin 341 for storing water A. Inside the water basin 341, there is a mist maker 343 for turning the water A into mist. On the side of the water basin 341, there is a heat exchanging element 342 attached, which could be a cooling chip 3421 with heat dissipation fins 3422. A water refiller 35 is positioned above the water basin 341, which has a refilling tube 352 extended into the water basin 341 and a bottle seat 351 extended outside of the top side of the watering member 3 for receiving a water bottle 36. A control element 33 is positioned on the top side of the watering member 3 which is wired to the mist maker 343 and the heat exchanging element 342 separately. The control element 33 then can automatically and periodically activate mist maker 343 to turn the water A into mist and the heat exchanging element 342 to adjust the temperature of the water A into an appropriate range. Please note that the control element 33 allows a user to set a specific temperature and a specific period of operation.

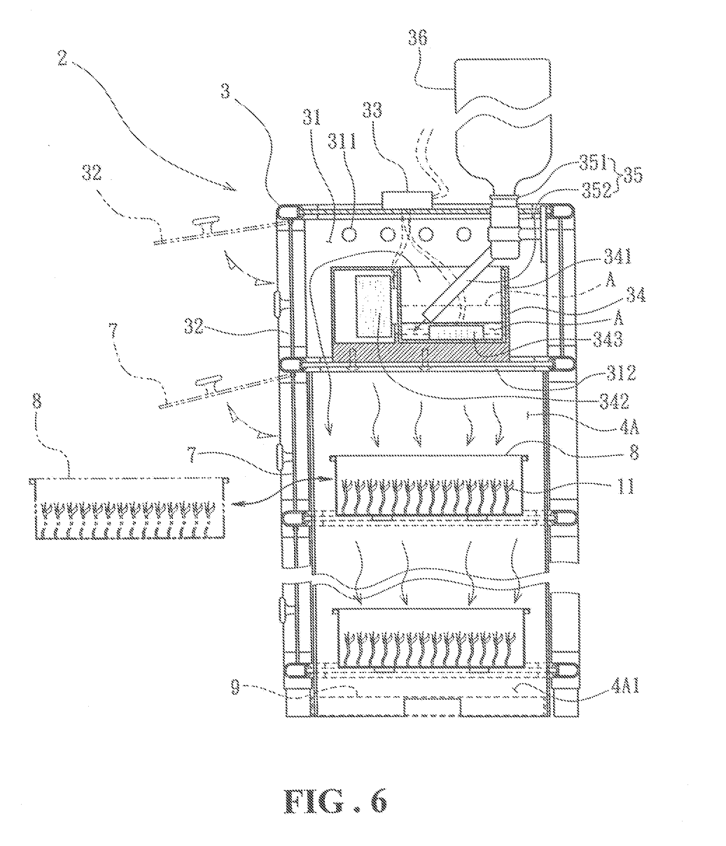

As shown in FIG. 6, the produced mist is mixed with external air entering the chamber 31 via the ventilation holes 311 and the mixture descends down the levels of the space 4A to irrigate the sprouts 11 in the culture dish 8 at each level. When there is too much mist, the extraneous moist is collected by the water collection dish 9 at the bottom opening 4A1. On the other hand, when there is not enough water in the water basin 341, the water refiller 35 is engaged and the water in the water bottle 36 is introduced into the water basin 341 via the refilling tube 352 until the water level is back to a specific height. The foregoing process is constantly repeated until the sprouts 11 are ready for harvest. Then, the doors 7 are flipped open to retrieve the culture dishes 8 and the sprouts 11. The door 32 of the water member 3 can also be flipped open for easy cleaning and maintenance of the chamber 31 and the mist production element 34.

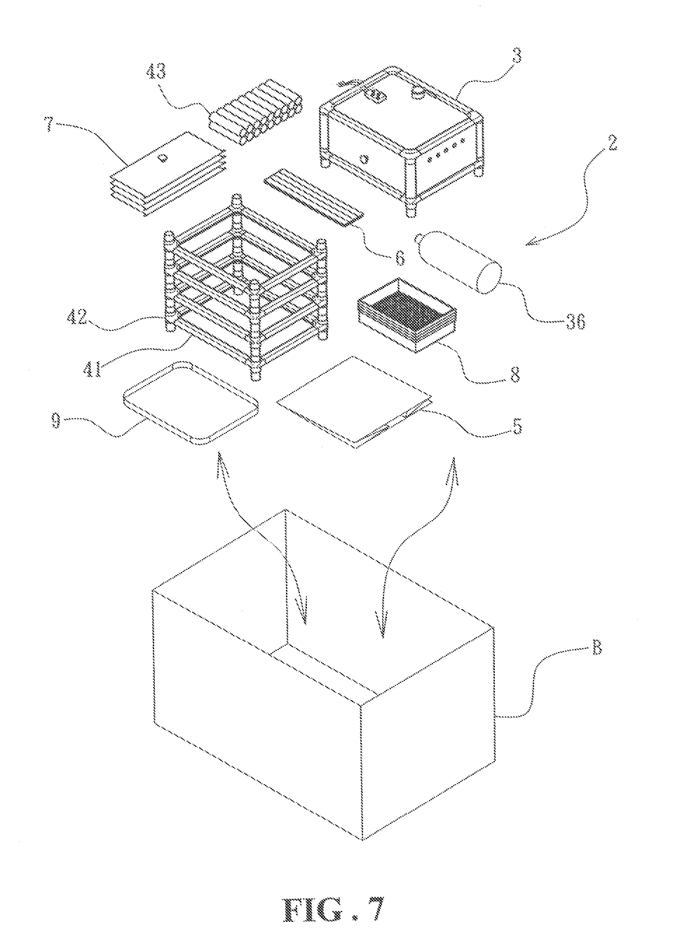

As shown in FIG. 7, when the cultivation device 2 is not in use, it can be easily disassembled into various parts and stored in a box B for efficient and economical storage. On the other hand, when the cultivation device 2 is needed, these parts can also be easily took out from the box B and assembled together.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A sprout cultivation device comprising:
a rack having a plurality of shelf members stacked vertically, each shelf member having open top and bottom sides, a culture dish being held inside each shelf member; and
a watering member stacked on the topmost shelf member of said rack, said watering member having an open bottom side, a mist production element being held inside said watering member capable of producing mist automatically and periodically.

2. The sprout cultivation device according to claim 1, wherein said mist production element comprising:
a water basin;
a mist maker positioned inside said water basin capable of turning the water of said water basin into mist;
a heat exchanging element for controlling the temperature of the water in said water basin; and
a water refiller positioned above said water basin capable of refilling said water basin until the water level of said water basin reaches a threshold.

3. The sprout cultivation device according to claim 2, wherein said heat exchanging element comprising a cooling chip and a heat dissipation fin attached to said cooling chip.

4. The sprout cultivation device according to claim 1, wherein said mist production element further comprises a control element capable of engaging said mist maker periodically according to a specific interval and said heat exchanging element to adjust the water temperature to a specific value.
